(19) United States
(12) Patent Application Publication
(10) Pub. No.: US 2011/0216437 A1
(43) Pub. Date: Sep. 8, 2011

(54) REAL-TIME GAIN IDENTIFICATION

(75) Inventors: Priyadarshee D. Mathur, Shakopee, MN (US); Peng Yan, Eagan, MN (US); Chiyun Xia, Bloomington, MN (US)

(73) Assignee: SEAGATE TECHNOLOGY LLC, Scotts Valley, CA (US)

(21) Appl. No.: 12/716,408

(22) Filed: Mar. 3, 2010

(51) Int. Cl. G11B 19/02

(52) U.S. Cl. 360/69; G9B/19.001

(57) ABSTRACT

A real-time gain identification system for a mechatronic system, such as a servo system, including at least two actuators is provided. In an example implementation, a servo system comprises a primary actuator and a piezoelectric secondary actuator. A controller generates a disturbance for one of the actuators that is compensated for (e.g., canceled) using another actuator. In one implementation, a gain of the actuator at an arbitrary time is calculated based upon a comparison of a signal used to compensate for the disturbance (e.g., cancel the disturbance) at that arbitrary time to a signal known to compensate for a disturbance (e.g., cancel the disturbance) under known conditions. For example, a gain may be determined based on a ratio of a signal used to cancel a disturbance at an arbitrary point to a signal known to cancel the disturbance under known conditions. Similar methodologies can be applied in other mechatronic systems with multiple actuators.

### BACKGROUND

Actuators used in mechatronic systems, such as servo systems including disc drives, often have wide response or gain variations. Piezoelectric elements used in dual-stage actuators for a disc drive, for example, may provide widely varying movement from part to part and in response to temperature variations. Attempts to calibrate the individual actuators have included pre-calibrating individual actuators during a manufacturing or assembly process or calibrating the actuators off-line. Since actuator performance can vary widely depending on temperature, a pre-calibration step is typically performed over widely varying temperature ranges (e.g., over the entire operational temperature range of a device). Although calibrating the actuator off-line allows for determining the gain based on current operating conditions in a disc drive, the disc drive switches off-line to make the calculation and, thus, loses operating time.

### SUMMARY

Implementations described and claimed herein provide real-time gain identification for a mechatronic system, such as a servo system, including at least two actuators. In an example implementation, a servo system comprises a primary actuator and a piezoelectric secondary actuator. A controller generates a disturbance for one of the actuators that is compensated for (e.g., canceled) using another actuator. In one implementation, a gain of the actuator at an arbitrary time is calculated based upon a comparison of a signal used to compensate for the disturbance (e.g., cancel the disturbance) at that arbitrary time to a signal known to compensate for a disturbance (e.g., cancel the disturbance) under known conditions. For example, a gain may be determined based on a ratio of a signal used to cancel a disturbance at an arbitrary point to a signal known to cancel the disturbance under known conditions. Similar methodologies can be applied in other mechatronic systems with multiple actuators.

In one implementation, for example, a method comprises providing an adaptive feed forward compensation signal to a first actuator to compensate for a disturbance provided by introducing a signal to a second actuator. The compensation signal may comprise at least one of a voltage compensation signal and a current compensation signal. An actuator gain is determined based on the introduced signal and a default signal known to compensate for the disturbance under a default operating condition. In one implementation, for example, the actuator gain is determined based on a ratio of the injected signal and the default signal. The actuator gain, for example, can be compared to a default gain value to determine a change in gain value that is attributable to a change in operating conditions.

In one particular implementation, the adaptive feed forward compensation signal is provided to the first actuator in real-time during operation of a data storage device without the data storage device being off-line. In another implementation, the adaptive feed forward compensation signal is provided to the first actuator continuously during at least a portion of an operation of the data storage device. In yet another implementation, the adaptive feed forward compensation signal is provided to the first actuator substantially simultaneously with the signal introduced to the second actuator. In another implementation, the adaptive feed forward compensation signal provides a consistent closed loop bandwidth under varying operating conditions, such as varying temperature.

In another implementation, a method comprises injecting a disturbance signal into a first actuator of a data storage device to provide a disturbance via the first actuator; and providing an adaptive feed forward compensation signal to a second actuator to cancel the disturbance provided via the first actuator.

A data storage device comprising a controller configured to introduce a disturbance signal into a first actuator of the data storage device to provide a disturbance in the first actuator and to provide an adaptive feed forward compensation signal to compensate for the disturbance in the first actuator is also provided.

Other implementations are also described and recited herein.

### BRIEF DESCRIPTIONS OF THE DRAWINGS

FIG. 1 illustrates an example computer equipped with a motherboard and a hard disc drive.

FIG. 2 illustrates a plan view of an example disc drive.

FIG. 3 illustrates example operations for an implementation of a system for determining a gain of an actuator of a data storage device.

FIG. 4 illustrates an example block diagram of a system 400 for determining a gain of an actuator of a data storage device.

FIG. 5 illustrates an example graph showing a sensitivity change with respect to a gain of the piezoelectric actuator of the system shown in FIG. 4 at different temperatures for an example hard disc drive.

FIG. 6 illustrates another example graph in which non-repeatable run out and repeatable run out frequencies are plotted for the example hard disc drive used in FIGS. 4 and 5.

FIG. 7 illustrates yet another example graph showing a relative amplitude of an injection signal Hz and the non-repeatable runout and repeatable runout frequency components shown in FIG. 6.

FIG. 8 illustrates another example graph showing a track mis-registration (TMR) difference without a gain identification system injected signal.

FIG. 9 illustrates yet another example graph showing a track mis-registration (TMR) difference with a gain identification system injected signal.

FIG. 10 illustrates another example graph showing coefficients from the adaptive feed forward compensation system shown in FIG. 4 at different temperatures.

FIG. 11 illustrates yet another example graph showing loop shapes for gain versus frequency.

FIG. 12 illustrates an example block diagram of an alternative implementation of a system for determining a gain of an actuator of a data storage device, such as a hard disc drive, to the system 400 shown in FIG. 4.

### DETAILED DESCRIPTIONS

A system and method for providing an adaptive feed forward compensation signal to an actuator that compensates for (e.g., cancels) a disturbance provided by introducing a disturbance signal to another actuator is provided. An adaptive feed forward voltage compensation can be simultaneously enabled with the introduction of the disturbance signal to compensate for (e.g., cancel) the disturbance caused by the disturbance signal.

The adaptive feed forward compensation signal may be used to determine a gain of at least one of the actuators by comparing the adaptive feed forward compensation signal to a signal known to compensate for the disturbance under a known operating condition. In one implementation, for example, the gain is averaged and recorded for use in controlling an actuator of a mechatronic device.

A gain identification system may be selectively operated depending upon operating conditions of a device. In a hard disc drive, for example, may be active only in read seek mode and when the drive is in tracking mode, but inactive in other modes such as a write mode. The gain identification system may be disabled after a digital-to-analog (DAC) gain compensation is being corrected. The gain identification system may also be re-enabled when a temperature change greater than a predetermined threshold is detected.

In one particular implementation, the adaptive feed forward compensation signal is provided to the first actuator in real-time during operation of a data storage device without the data storage device being off-line. In another implementation, the adaptive feed forward compensation signal is provided to the first actuator continuously during at least a portion of an operation of the data storage device. In yet another implementation, the adaptive feed forward compensation signal is provided to the first actuator substantially simultaneously with the signal introduced to the second actuator. In another implementation, the adaptive feed forward compensation signal provides a consistent closed loop bandwidth under varying operating conditions, such as varying temperature.

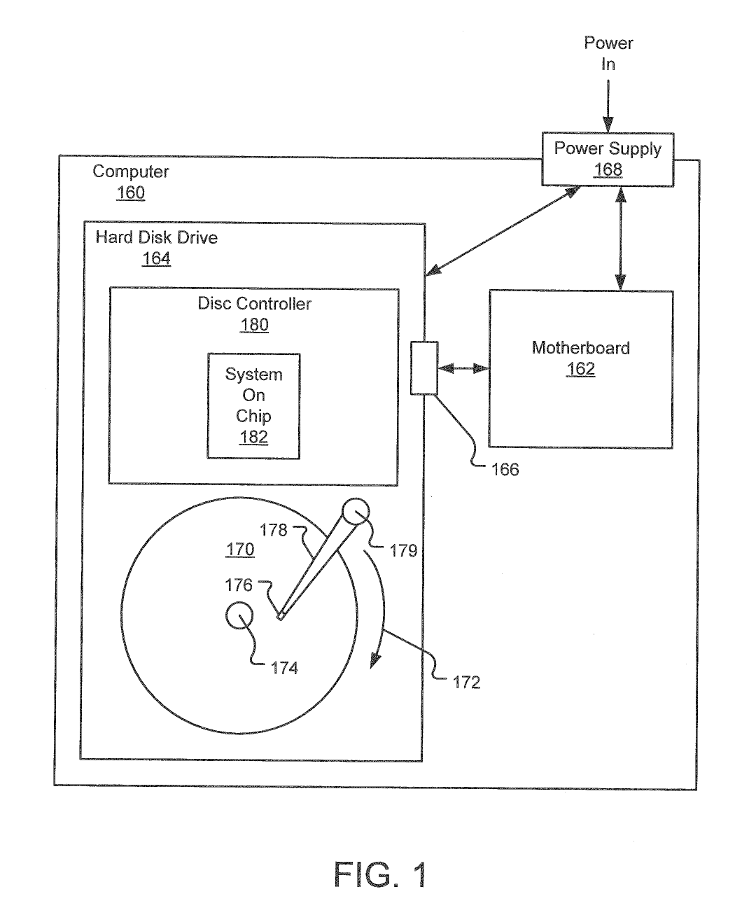

FIG. 1 illustrates an example computer 160 equipped with a motherboard 162 and a hard disc drive (HDD) 164, which is one type of mechatronic system that may provide two or more actuators. The computer 160 may comprise any server, desktop, laptop, or other computing system. The computer, 160, for example, operatively couples various system components (e.g., HDD 164) using at least the motherboard 162. In one implementation, the motherboard 162 and the HDD 164 are connected together via a Serial ATA interface 166, however, other connection schemes are contemplated. Through the motherboard 162, the computer controls operation of the HDD 164.

Both the motherboard 162 and the HDD 164 are powered by a power supply 168 that may convert incoming AC power to DC power, step down an incoming voltage, step-up the incoming voltage, and/or limit current available to the motherboard 162 and the HDD 164. In one implementation, power for the HDD 164 comes from the power supply 168 through the motherboard 162.

The HDD 164 is equipped with a disc pack 170, which is mounted on a spindle motor (not shown). The disk pack 170 includes one or more individual disks, which rotate in a direction indicated by arrow 172 about a central axis 174. Each disk has an associated disc read/write head slider 176 for communication with the disk surface. The slider 176 is attached to one end of an actuator arm 178 that rotates about a pivot point 179 to position the slider 176 over a desired data track on a disk within the disk pack 170.

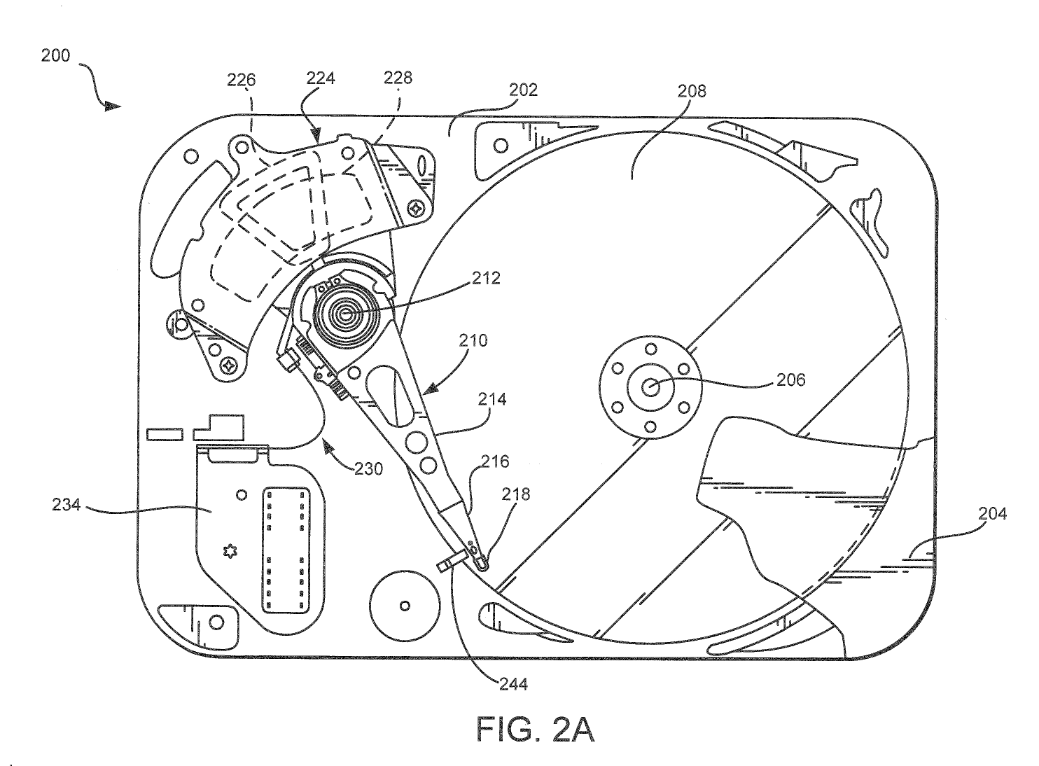

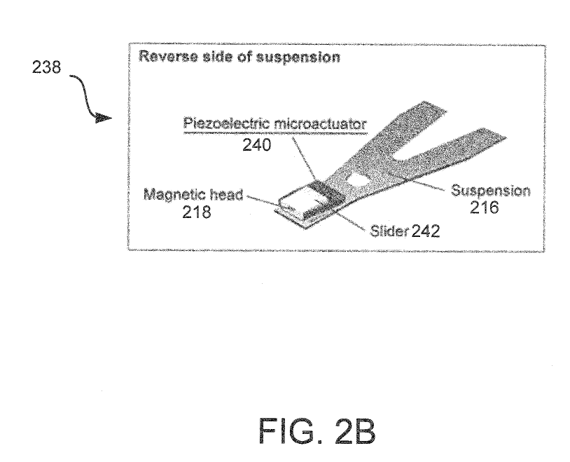

The HDD 164 is also equipped with a disc controller 180 that controls operation of the HDD 164. The disc controller 180, for example, may reside on a printed circuit board (PCB). The disc controller PCB 180 may include a system-on-a-chip (SOC) 182 that combines some, many, or all functions of the PCB 180 on a single integrated circuit. Alternatively, the functions of the PCB 180 may be spread out over a number of integrated circuits within one package (i.e., SIP). The HDD 164 is discussed further with regard to FIGS. 2A and 2B.

FIG. 2A illustrates a plan view of an example disc drive 200. FIG. 2B shows an enlarged view of an underside of a head portion of the disc drive 200 shown in FIG. 2A. The disc drive 200 includes a base 202 to which various components of the disc drive 200 are mounted. A top cover 204, shown partially cut away, cooperates with the base 202 to form an internal, clean environment for the disc drive in a conventional manner. The components include a spindle motor 206 that rotates one or more storage medium discs 208 at a constant high speed. Information is written to and read from tracks on the discs 208 through the use of an actuator assembly 210, which rotates during a seek operation about a bearing shaft assembly 212 positioned adjacent the discs 208.

The disc drive 200, for example, may comprise a single or multiple stage actuator assembly 210 for controlling movement of a transducer with respect to one of the storage medium discs 208. In one particular implementation, for example, the actuator assembly 210 comprises a dual-stage actuator assembly in which a first stage (e.g., a voice coil motor 224) is optimized for moving a transducer relatively large distances and a second stage (e.g., a piezoelectric actuator 240) is optimized for moving the transducer relatively small distances. In the example implementation shown in FIG. 2B, for example, a flexure 216 supports a magnetic transducer head 218, a slider 242, and a piezoelectric microactuator 240. However, other implementations are also possible.

The actuator assembly 210 further includes a plurality of actuator arms 214 that extend towards the discs 208, with one or more flexures 216 extending from each of the actuator arms 214. Mounted at the distal end of each of the flexures 216 is a head 218 that includes an air bearing slider enabling the head 218 to fly in close proximity above the corresponding surface of the associated disc 208. The distance between the head 218 and the storage media surface during flight is referred to as the fly height.

During a seek operation, the track position of the head 218 is controlled through the use of a voice coil motor (VCM) 224, which typically includes a coil 226 attached to the actuator assembly 210, as well as one or more permanent magnets 228 which establish a magnetic field in which the coil 226 is immersed. The controlled application of current to the coil 226 causes magnetic interaction between the permanent magnets 228 and the coil 226 so that the coil 226 moves in accordance with the well-known Lorentz relationship. As the coil 226 moves, the actuator assembly 210 pivots about the bearing shaft assembly 212 and the transducer heads 218 are caused to move across the surfaces of the discs 208.

The spindle motor 206 is typically de-energized when the disc drive 200 is not in use for extended periods of time. The transducer heads 218 are moved away from portions of the disk 208 containing data when the drive motor is de-energized. The transducer heads 218 are secured over portions of the disk not containing data through the use of an actuator latch arrangement and/or ramp assembly 244, which prevents inadvertent rotation of the actuator assembly 210 when the drive discs 208 are not spinning.

A flex assembly 230 provides the requisite electrical connection paths for the actuator assembly 210 while allowing pivotal movement of the actuator assembly 210 during operation. The flex assembly 230 includes a printed circuit board 234 to which a flex cable connected with the actuator assembly 210 and leading to the head 218 is connected. The flex cable may be routed along the actuator arms 214 and the flexures 216 to the transducer heads 218. The printed circuit board 234 typically includes circuitry for controlling the write currents applied to the transducer heads 218 during a write operation, a preamplifier for amplifying read signals generated by the transducer heads 218 during a read operation, and a power supply to a head heater, which allows fine head to disk clearance control by setting the head temperature near the active head elements. The flex assembly 230 terminates at a flex bracket for communication through the base deck 202 to a disc drive printed circuit board (not shown) mounted to the bottom side of the disc drive 200.

The printed circuit board 234 can include firmware used to determine a gain of an actuator. In one implementation, for example, firmware residing on the printed circuit board 234 may be used to introduce a disturbance in a first actuator stage of the disc drive 200 and to compensate for (e.g., cancel) a disturbance in a second actuator stage of the disc drive.

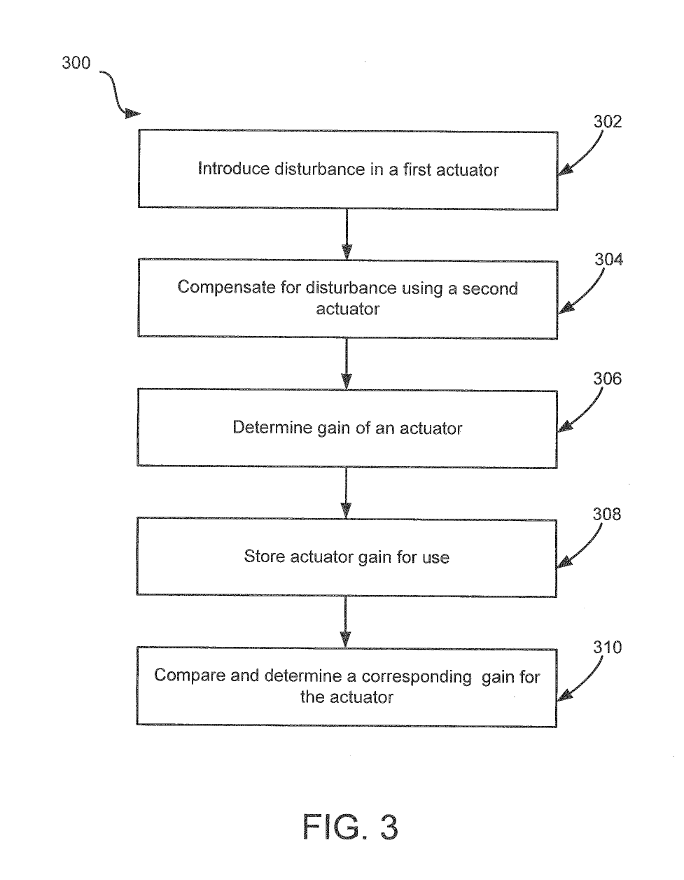

FIG. 3 illustrates example operations 300 for an implementation of a system for determining a gain of an actuator of a mechatronic device including at least two actuators. In one particular implementation, for example, the mechatronic device comprises a servo system data storage device having at least two actuators, such as a hard disc drive having a dual-stage actuator, although a gain may be similarly determined in other mechatronic devices having at least two actuators.

In the implementation shown in FIG. 3, a disturbance is introduced to (e.g., injected into) a first actuator of a mechatronic device in operation 302. In one particular implementation, for example, a hard disc drive may comprise a dual-actuator system including a voice coil motor first actuator for gross motor control and a piezoelectric second microactuator for fine motor control. In this implementation, the disturbance may be introduced in the voice coil motor first actuator and/or the piezoelectric second actuator of the dual-actuator system of the hard disc drive. The disturbance may be introduced in a voice coil motor actuator, for example, by injecting a current signal through the voice coil motor actuator. The current signal may be at a predefined or at a user or designer-specified frequency.

The disturbance is then compensated for (e.g., canceled) using another actuator of the mechatronic device in operation 304. At least one of the two actuators used for either injecting the disturbance or compensating for (e.g., canceling) the disturbance is the actuator for which a gain is to be determined. Note that this particular implementation demonstrates real-time piezoelectric actuator gain identification, assuming that the voice coil motor actuator gain (under different temperatures and different part-to-part) remains consistent (or at least relatively consistent). However, it is also possible to deploy this methodology on multiple stage actuators to collectively identify the actuator gains on different stages. An adaptive feed forward voltage compensation system, for example, may be simultaneously or closely enabled to compensate for (e.g., cancel) the disturbance introduced in the introducing operation 302. Where the disturbance is introduced through a current signal injected in a voice coil motor first actuator of a dual actuator system, for example, a piezoelectric second actuator may be used to compensate (e.g., cancel) the disturbance introduced via the voice coil motor first actuator.

A gain of an actuator is then determined in operation 306. In one implementation, example, the gain is determined based upon a ratio of the signal used to compensate for (e.g., cancel) the introduced disturbance to a signal known to compensate for (e.g., cancel) a disturbance introduced under known conditions (e.g., a default or base line signal). The gain, for example, can be used to compensate for variations introduced by an actuator. In one particular implementation, for example, a feed forward actuator gain can be averaged over time and stored for use within the hard disc drive in operation 308. The feed forward gain, for example, can be stored within servo code execution, such as coefficients for use in the operation of the hard disc drive (e.g., as L2 coefficients).

A corresponding controller gain is then determined in operation 310. Where the determined gain is averaged over a given time period (e.g., a predetermined number of cycles), the averaged gain can be compared to a default gain value. The ratio of the determined gain to the default gain value reflects the gain change due to operating variations (e.g., temperature) for an actuator. In one particular implementation, for example, this ratio can be multiplied to the default actuator gain to generate the actual gain of the actuator under the given operating conditions.

A gain determination system may be selectively activated based on any number of factors. The gain determination system, for example, may be active only during certain operating conditions but not during other operating conditions. In one implementation, for example, the gain determination system may be activated in read seek and tracking modes of a hard disc drive, but inactive during all other modes of operation of the hard disc drive. In another implementation, the gain determination system may be turned off while the gain compensated is being corrected (e.g., based on the determined gain). In yet another implementation, the gain determination system can be activated when a change in operating conditions (e.g., temperature) is detected.

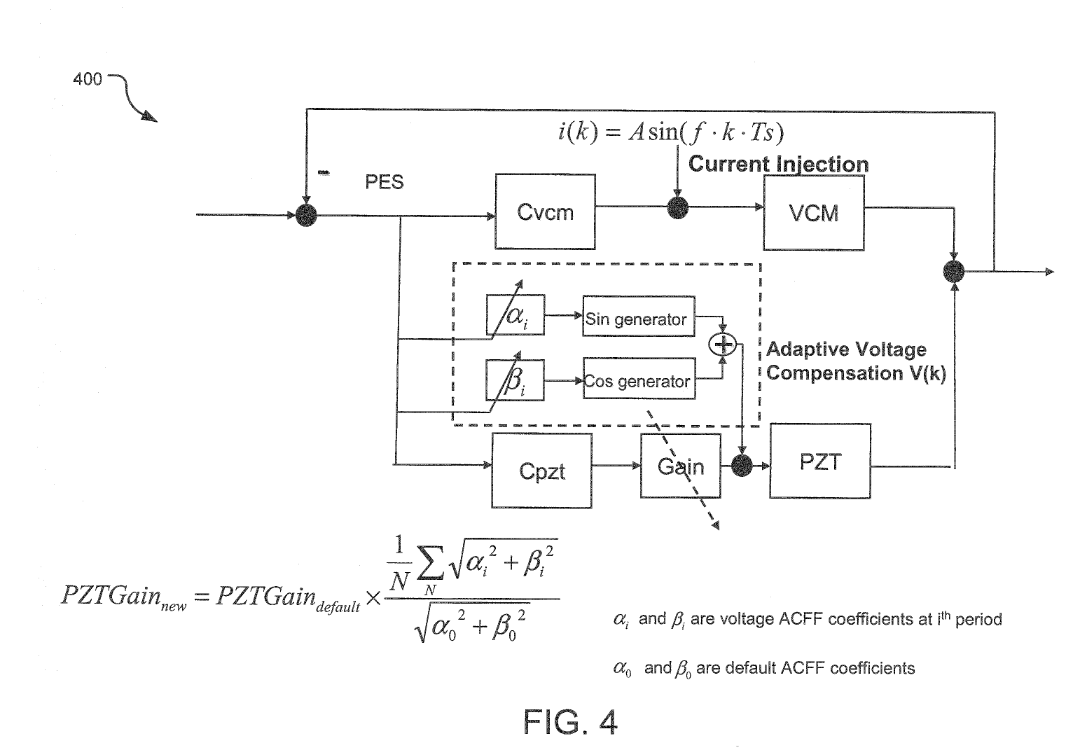

FIG. 4 shows one example of a block diagram of a system 400 for determining a gain of an actuator of a data storage device, such as a hard disc drive. In this particular implementation, an actuator comprises a dual actuator system that includes a voice coil motor first actuator (VCM) for gross motor control and a piezoelectric second actuator (PZT) for fine motor control. In this particular implementation, the system 400 comprises a first controller (C_{VCM}) for controlling the voice coil motor first actuator (VCM) and a second controller (C_{PZT}) for controlling the piezoelectric second actuator (PZT). Although the controllers (C_{VCM}) and (C_{PZT}) are shown as two controllers in the block diagram, the controllers may be implemented individually or as part of a single controller comprising at least two outputs. As used herein, the term “a controller” may thus refer to a single controller or multiple individual controllers that perform any recited function(s).

The system 400 determines a gain of the piezoelectric second actuator (PZT) based on current operating conditions (e.g., temperature) of the hard disc drive. In this particular implementation, for example, the gain variation of the piezoelectric actuator is significantly greater (by orders of magnitude) than the gain variation of the voice coil motor actuator (VCM). Thus, the determined gain may be associated with the operation of the piezoelectric actuator (PZT).

In FIG. 4, a disturbance is introduced by injecting a current in the voice coil motor (VCM). In one implementation, for example, the current may be injected into the voice coil motor via a current disturbance injection node. The injection node can be implemented as a summation of the voice current control command and the signal to be injected. In this implementation, a frequency of 2080 Hz is selected as an example current signal injection frequency, although other frequencies could also be used.

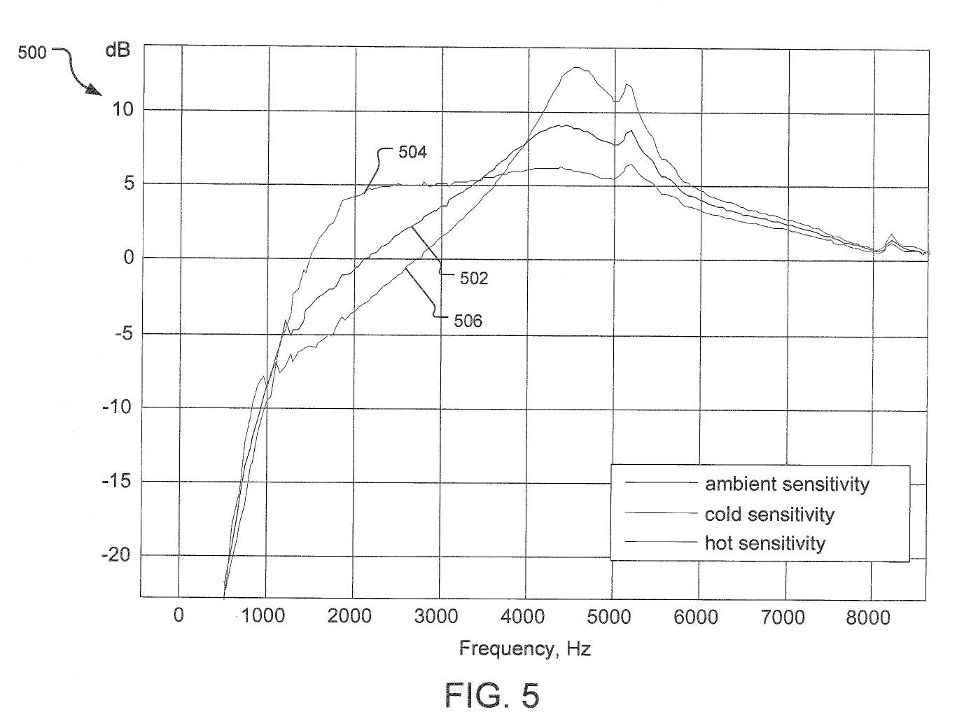

FIG. 5 illustrates an example graph 500 showing a closed loop sensitivity with respect to gain variations of the piezoelectric actuator of the system shown in FIG. 4 at different temperatures for an example hard disc drive. In the example graph shown in FIG. 5, for example, a gain of the closed loop sensitivity is shown on a vertical axis in dB and a frequency is shown on a horizontal axis. In this example, graphs of three gains are shown with respect to a temperature of the disc drive: (1) for an ambient temperature 502 at 35 degrees C., (2) for a relatively cold temperature 504 at 5 degrees C., and (3) for a relatively hot temperature 506 at 52 degrees C. As can be seen in the graph of FIG. 5, the sensitivity of the closed loop induced by the piezoelectric actuator (PZT) to temperature variations varies with frequency. At frequencies below 1000 Hz and above 6000 Hz, for example, the gain of sensitivity is relatively stable for the temperature variations shown. Between these frequencies, however, the gain varies significantly based upon the operating temperature of the hard disc drive.

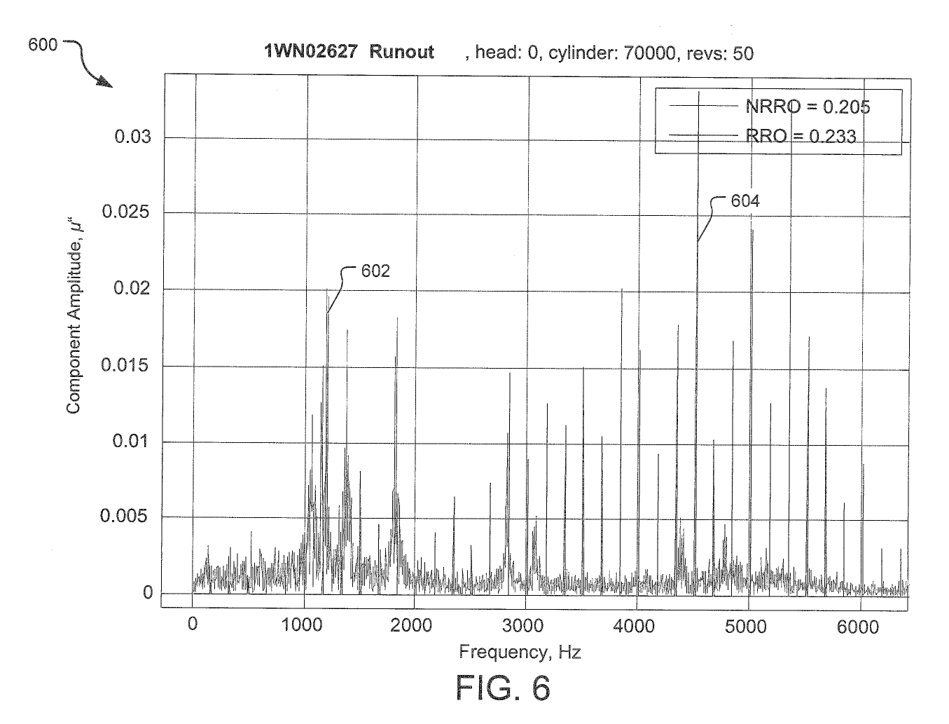

FIG. 6 illustrates another example frequency domain graph 600 in which non-repeatable run out 602 and repeatable run out 604 frequency components are plotted for the example hard disc drive of FIGS. 4 and 5. In the example graph of FIG. 6, the plotted amplitudes of the frequency components for the non-repeatable run out 602 and repeatable run out 604 are shown in micro-inches and correspond to a general disturbance level from a center of a disc track without the presence of a gain identification disturbance injection.

In the example shown in FIG. 5, for example, the closed loop gain induced by variations of the piezoelectric actuator is very sensitive to changes in operating temperatures at the frequency of 2080 Hz selected for the current injection signal for the system shown in FIG. 4. Thus, an injection signal having a frequency of 2080 Hz allows for relatively simpler gain determination. FIG. 6 further shows the non-repeatable run out and repeatable run out frequency components are not significant at the selected current injection signal frequency of 2080 Hz. Thus, the selection of an injection current frequency of 2080 Hz is unlikely to interfere with non-repeatable run out or repeatable run out frequency components.

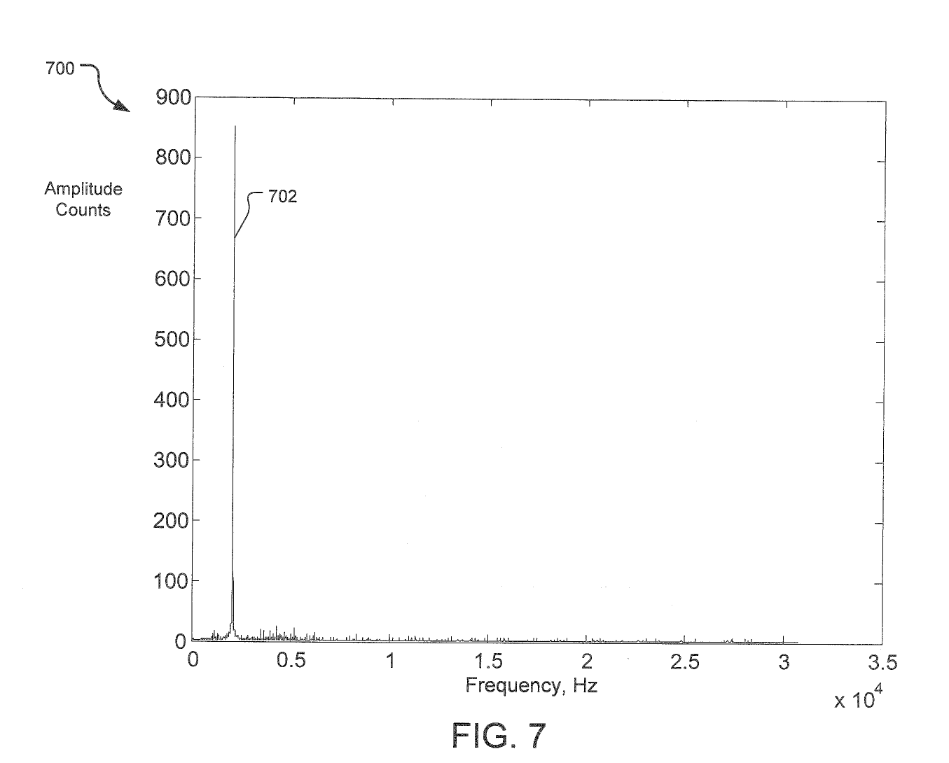

FIG. 7 illustrates an example graph 700 showing a relative amplitude of an injection signal 702 at 2080 Hz and the non-repeatable run out and repeatable run out frequency components shown in FIG. 6. As can be seen in the example of FIG. 7, the amplitude of the injection signal 702 is significantly greater than the amplitudes of the non-repeatable run out and repeatable run out frequency components, which can provide at least a minimum signal to noise ratio.

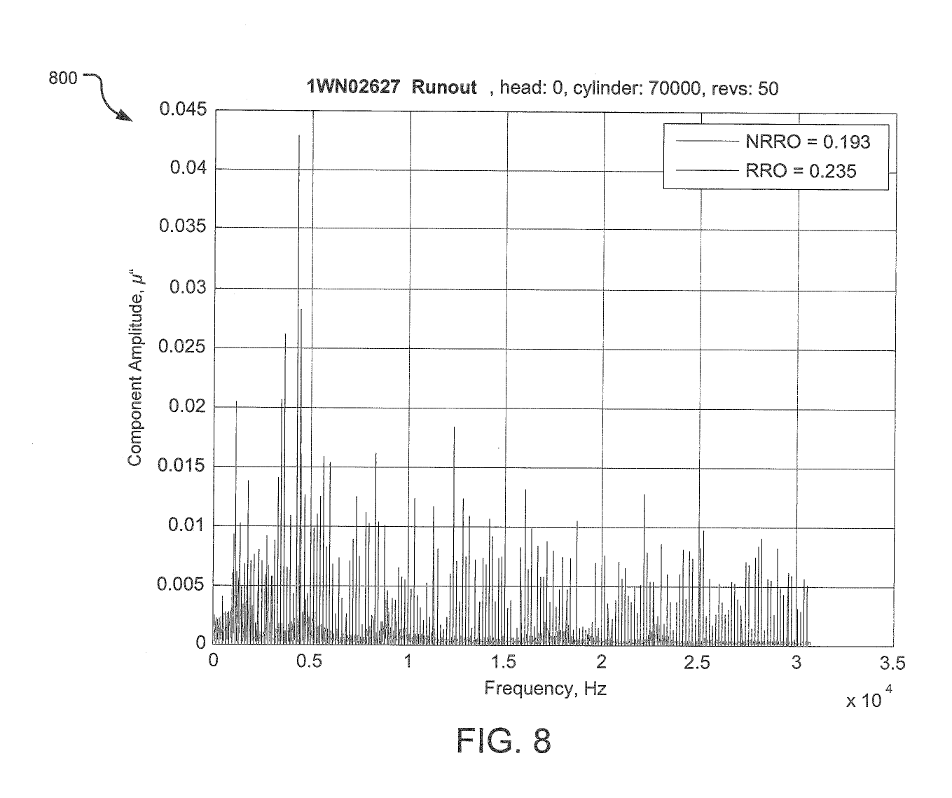

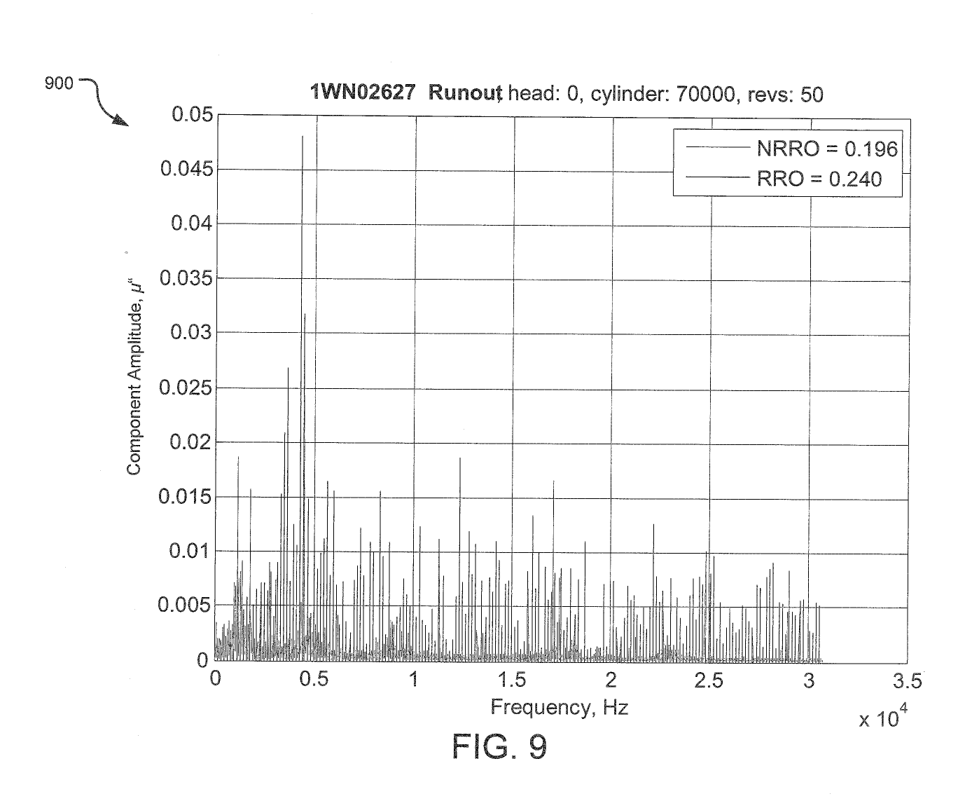

FIGS. 8 and 9 depict example graphs 800 and 900, respectively, showing a track mis-registration (TMR) difference without a gain identification system injected signal (FIG. 8) and with a gain identification system injected signal having a frequency of 2080 Hz (FIG. 9). As can be seen in this example by comparing FIGS. 8 and 9, the difference in track mis-registration is negligible in this example, although the internal current injection at 2080 HZ is significant as shown in FIG. 7.

In the example system shown in FIG. 4, an adaptive feed forward compensation system is implemented to compensate for the current injection signal as follows:

Feed Forward Voltage: V(k)=α(i)sin(f·k·Tₛ+Θ₀)+β(i)cos(f·k·Tₛ+Θ₀).

Coefficients:

α(i+1)=α(i)+K₀·Σ sin(f·k·Tₛ)*PES(k)

β(i+1)=β(i)+K₀·Σ cos(f·k·Tₛ)*PES(k)

where i is a signal period counter, k is a sector counter, and K₀ and Θ₀ are pre-tuned parameters. For every N signal periods (e.g., N=64 signal periods in this example), a piezoelectric gain can be identified with the following scheme:

$${PZTGain}_{new} = {PZTGain}_{default} \times \frac{\sqrt{{α}_{0}^{2} + {β}_{0}^{2}}}{\frac{1}{N} {\sum }_{N}^{ } \sqrt{{α ( i )}^{2} + {β ( i )}^{2}}}$$

Where α₀ and β₀ are default voltage compensation coefficients.

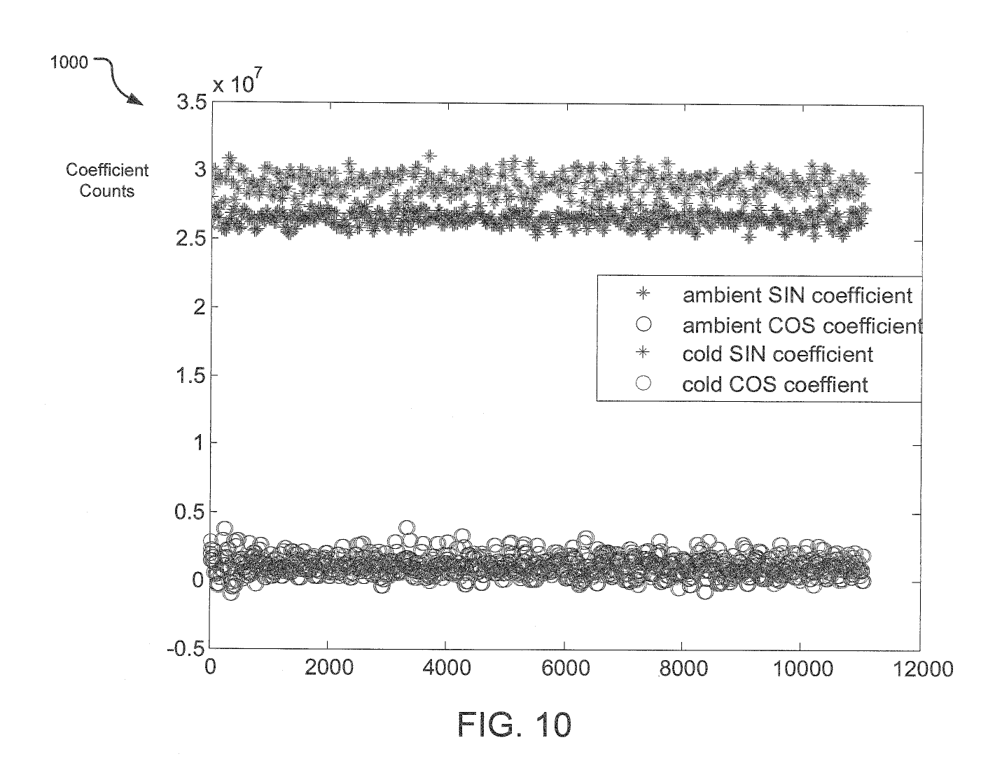

FIG. 10 illustrates another example graph 1000 showing coefficients from the adaptive feed forward compensation system shown in FIG. 4 at different temperatures. In this example, the hard disc drive has further been tested in a servo chamber with temperature cycling from ambient (30 degree C.) to cold (5 degree C.). As depicted in FIG. 10, an adaptive voltage gain reflects the actuator gain change with respect to changes in temperature, with which the desired DAC gain can be obtained.

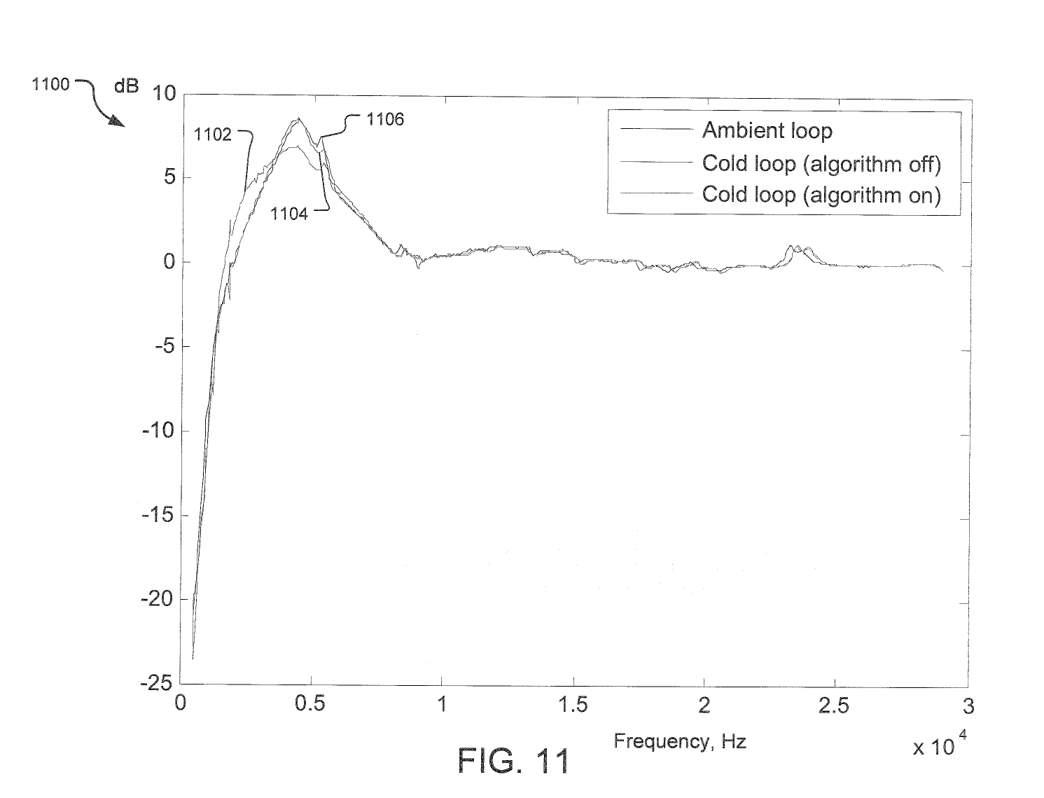

FIG. 11 illustrates another example graph 1100 showing loop shapes for gain versus frequency. As depicted in FIG. 11, the loop shape is significantly off at cold temperature without a gain determination algorithm (loop 1102), while the piezoelectric identification online can be used to correct the DAC gain compensation and the loop shape with the proposed gain determination algorithm (loop 1104) can match the default loop shape at an ambient temperature (loop 1106) very well.

In this particular implementation, the gain identification algorithm provides no (or relatively low) track mis-registration (TMR), and no (or relatively low) drive level performance degradation, accurate and fast convergence. In addition, an auto turn-on/turn-off feature can be used to improve the potential impact of increased power consumption and piezoelectric lifetime reliability due to internal current injection and voltage adaptive compensation.

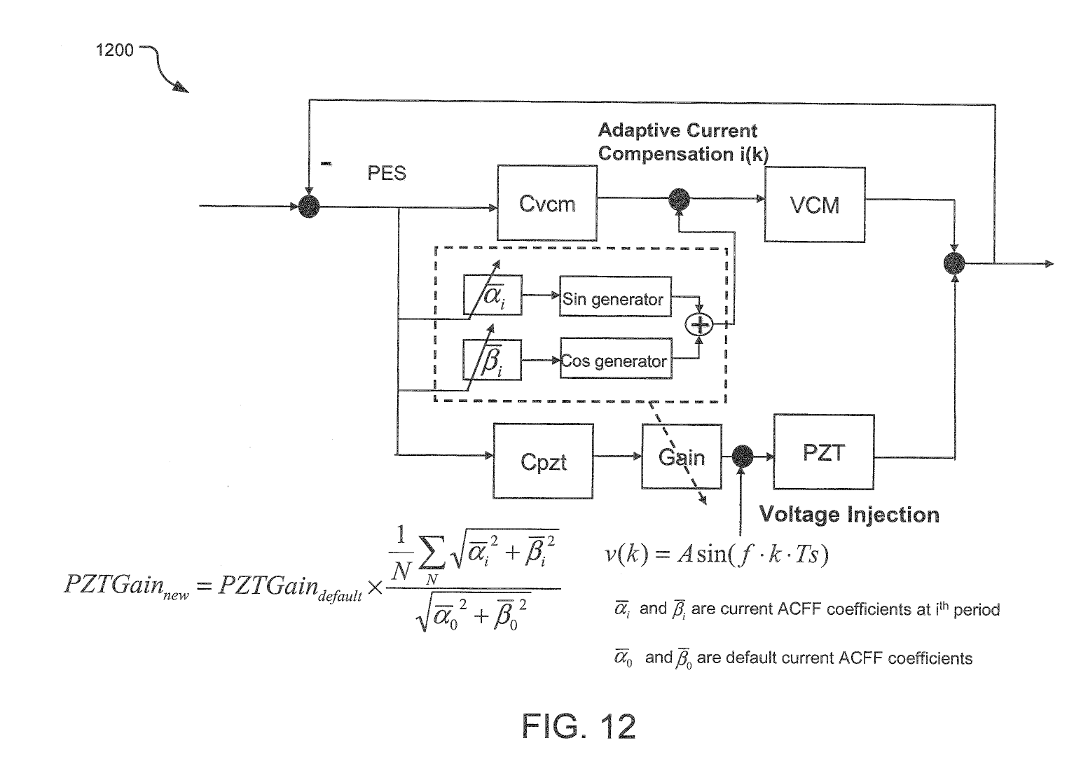

FIG. 12 illustrates an example block diagram 1200 of an alternative implementation of a system 1100 for determining a gain of an actuator of a data storage device, such as a hard disc drive, to the system 400 shown in FIG. 4. In the implementation shown in FIG. 12, for example, a voltage signal is injected into a piezoelectric actuator (PZT) of a hard disc drive to create a disturbance and a feed forward adaptive current compensation is used to compensate for (e.g., cancel) the disturbance.

In the embodiment shown in FIG. 12, an adaptive feed forward current compensation system is implemented to compensate for the current injection signal as follows:

Feed Forward Current: I(k)= α̅(i)sin(f·k·Tₛ+ Θ̅₀)+ β̅(i)cos(f·k·Tₛ+ Θ̅₀)

Coefficients:

α̅(i+1)= α̅(i)+ K̅₀Σ sin(f·k·Tₛ)*PES(k)

β̅(i+1)= β̅(i)+ K̅₀Σ cos(f·k·Tₛ)*PES(k)

where i is a signal period counter, k is a sector counter, K̅₀ and Θ̅₀ are pre-tuned parameters. For every N signal periods (e.g., N=64 signal periods in this example), a piezoelectric gain can be identified with the following scheme:

$${PZTGain}_{new} = {PZTGain}_{default} \times \frac{\frac{1}{N} {\sum }_{N}^{ } \sqrt{{\overline{α}}_{i}^{2} + {\overline{β}}_{i}^{2}}}{\sqrt{{\overline{α}}_{0}^{2} + {\overline{β}}_{0}^{2}}}$$

Where α̅ᵢ and β̅ᵢ are voltage coefficients at the i^{th} period, and α̅₀ and β̅₀ are default current adaptive feed forward compensation coefficients.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
providing an adaptive feed forward compensation signal to a first actuator to compensate for a disturbance provided by introducing a signal to a second actuator.

2. The method of claim 1 wherein the compensation signal comprises at least one of a voltage compensation signal and a current compensation signal.

3. The method of claim 1 wherein an actuator gain is determined based on the introduced signal and a default signal known to compensate for the disturbance under a default operating condition.

4. The method of claim 3 wherein the actuator gain is determined based on a ratio of the injected signal and the default signal.

5. The method of claim 3 wherein the actuator gain is compared to a default gain value to determine a change in gain value.

6. The method of claim 5 wherein the change in gain value is due to a change in operating conditions.

7. The method of claim 1 wherein the adaptive feed forward compensation signal is provided to the first actuator in real-time during operation of a data storage device without the data storage device being off-line.

8. The method of claim 1 wherein the adaptive feed forward compensation signal is provided continuously during at least a portion of an operation of the data storage device.

9. The method of claim 1 wherein the adaptive feed forward compensation signal is provided to the first actuator simultaneously with the signal introduced to the second actuator.

10. The method of claim 1 wherein the adaptive feed forward compensation signal provides a consistent closed loop bandwidth under varying operating conditions.

11. A method comprising:
injecting a disturbance signal into a first actuator of a data storage device to provide a disturbance via the first actuator; and
providing an adaptive feed forward compensation signal to a second actuator to cancel the disturbance provided via the first actuator.

12. The method of claim 11 wherein the first actuator comprises a voice coil motor of a disc drive and the second actuator comprises a piezoelectric actuator of the disc drive, the disturbance signal comprises a current signal and the compensation signal comprises a feed forward voltage signal.

13. The method of claim 11 wherein the first actuator comprises a piezoelectric actuator of a disc drive and the second actuator comprises a voice coil motor of the disc drive, and the disturbance signal comprises a voltage signal and the compensation signal comprises a feed forward current signal.

14. The method of claim 11 wherein the injecting and providing operations are performed in real time during operation of the data storage device without the data storage device being off-line.

15. The method of claim 11 wherein the injecting and providing operations are performed continuously during at least a portion of an operation of the data storage device.

16. A data storage device comprising:
a controller configured to introduce a disturbance signal into a first actuator of the data storage device to provide a disturbance in the first actuator and to provide an adaptive feed forward compensation signal to compensate for the disturbance in the first actuator.

17. The data storage device of claim 16 wherein the controller is further adapted to determine an actuator gain based on a ratio of the introduced signal and a default signal known to compensate for the disturbance under a default operating condition.

18. The data storage device of claim 16 wherein the controller is configured to introduce the disturbance signal and provide the adaptive feed forward compensation signal in real-time during operation of a data storage device without the data storage device being off-line.

19. The data storage device of claim 16 wherein the controller is configured to introduce the disturbance signal and provide the adaptive feed forward compensation signal continuously during at least a portion of an operation of the data storage device.

20. The data storage device of claim 16 wherein the controller is configured to provide the adaptive feed forward compensation signal to the second actuator substantially simultaneously with the disturbance signal introduced to the first actuator.

21. The data storage device of claim 16 wherein the adaptive feed forward compensation signal provides a consistent closed loop bandwidth under varying operating conditions.
